(19) United States
(12) Patent Application Publication
(10) Pub. No.: US 2023/0297896 A1
(43) Pub. Date: Sep. 21, 2023

(54) METHOD AND SYSTEM FOR SEAT ASSIGNMENT IN HYBRID WORKING MODEL

(71) Applicant: JPMorgan Chase Bank, N.A., New York, NY (US)

(72) Inventors: Luke STORRIE, Christchurch (GB); Frank VAN HOOF, Ringwood (GB); Zoe BERRY, Essex (GB); Erik RITSEMA, Dorchester (GB); Jonathan M. BAUM, Brooklyn, NY (US); Tom MARTIN, Lewis Center, OH (US); Kendall BERG, Colorado Springs, CO (US); Rebecca CORNWELL, Dorset (GB); Rehaan DOUGLAS, Sugar Land, TX (US); Ella GASKIN, Southampton (GB); John MILLER, Bournemouth (GB)

(73) Assignee: JPMorgan Chase Bank, N.A., New York, NY (US)

(21) Appl. No.: 17/655,200

(22) Filed: Mar. 17, 2022

(51) Int. Cl. G06Q 10/02

(52) U.S. Cl. CPC G06Q 10/02

(57) ABSTRACT

A method for automatically assigning seats to a group of persons is provided. The method includes: receiving a first user input that relates to building space availability and a second user input that relates to employer requirements for seat occupancy; determining, based on the first and second user inputs, a building section within which seats are to be assigned to the group; and assigning, to each respective person within the group based on the first and second user inputs, a respective seat within the determined building section and a respective schedule during which the respective seat is to be occupied by the respective person. The assigning may be implemented by applying a machine learning algorithm that is trained by using historical data that relates prior seat occupancies of each respective person with the group.

### BACKGROUND

### 1. Field of the Disclosure

This technology generally relates to methods and systems for supporting a hybrid working model, and more particularly to methods and systems for automatically assigning seats to personnel based on behavioral patterns and hybrid work schedules that include working from home and working at an office at different times.

### 2. Background Information

For many decades, most jobs required that employees, contractors, and/or other personnel be physically present at a place of work. However, in more recent years, with the advent of the Internet and the World Wide Web, the possibility of working from home by using an online connection to employment-related resources has become more feasible. Further, even more recently as a result of the COVID-19 pandemic, working from home has become much more common than it was prior to the pandemic.

In the initial months of the pandemic, many workplaces were deemed unsafe, and as a result, some employers were forced to facilitate working from home to a greater degree than would be optimal. As society has made adjustments for coping with the pandemic, it has become safer to return to many such workplaces. However, many employees have found that they prefer working from home where feasible.

In order to strike a balance between employer objectives that are best served by having employees present at the office and employee preferences for flexibility, some employers have implemented hybrid work schedules by which employees are physically present at the office at certain times and working from home at other times.

A consequence of a hybrid working model is that there has been a reduction in the amount of office space that is required for a group of employees. Therefore, in order to reduce costs, many employers have downsized their workplaces. However, this downsizing has created a new requirement for assigning seats at the workplace to employees in a way that accommodates each individual employee's schedule while maximizing occupancy of the office.

Accordingly, there is a need for a methodology for automatically assigning seats to employees within the context of a hybrid work schedule model.

### SUMMARY

The present disclosure, through one or more of its various aspects, embodiments, and/or specific features or sub-components, provides, inter alia, various systems, servers, devices, methods, media, programs, and platforms for automatically assigning seats to personnel based on behavioral patterns and hybrid work schedules that include working from home and working at an office at different times.

According to an aspect of the present disclosure, a method for automatically assigning seats to a group of persons is provided. The method is implemented by at least one processor. The method includes: receiving, by the at least one processor, a first user input that relates to building space availability and a second user input that relates to employer requirements for seat occupancy; determining, by the at least one processor based on the first user input and the second user input, a building section within which seats are to be assigned to the group of persons; and assigning, by the at least one processor to each respective person within the group of persons based on the first user input and the second user input, a respective seat within the determined building section and a respective schedule during which the respective seat is to be occupied by the respective person.

The assigning may include applying a first algorithm that uses a machine learning technique to perform the assigning. The first algorithm may be trained by using historical data that relates to a prior seat occupancy pattern of each respective person with the group of persons.

The method may further include: transmitting, by the at least one processor to each respective person within the group of persons, seat assignment information that is generated as a result of the assigning; and receiving, by the at least one processor from at least one person within the group of persons, a response to the transmitting of the seat assignment information that indicates at least one from among a confirmation of the seat assignment information, a declination of the seat assignment information, and a proposed amendment to the seat assignment information.

The method may further include receiving, by the at least one processor, a third user input that includes at least one personal preference that relates to at least one person within the group of persons. The assigning of the respective seat and the respective schedule to the at least one person may be further based on the third user input.

The method may further include displaying, on a graphical user interface, an image that illustrates a result of the determining and the assigning.

The method may further include determining, by the at least one processor, at least one metric that relates to at least one from among building space availability and seat occupancy. The at least one metric may include at least one from among an average building occupancy, a seat occupancy percentage at a particular time, an average seat occupancy percentage over a particular week, and an average seat occupancy percentage over a particular month.

The method may further include generating a report that includes information that relates to maximizing seat occupancy and information that relates to a degree of adherence between the first user input, the second user input, and a result of the determining and the assigning.

The method may further include: receiving, by the at least one processor, actual occupancy information that indicates, for each respective seat on a particular day, whether the respective seat is actually occupied and an identification of a person occupying the respective seat; and comparing the actual occupancy information with a result of the determining and the assigning.

The method may further include displaying, on a graphical user interface, a result of the comparing.

According to another aspect of the present disclosure, a computing apparatus for automatically assigning seats to a group of persons is provided. The computing apparatus includes a processor; a memory; a display; and a communication interface coupled to each of the processor, the memory, and the display. The processor is configured to: receive, via the communication interface, a first user input that relates to building space availability and a second user input that relates to employer requirements for seat occupancy; determine, based on the first user input and the second user input, a building section within which seats are to be assigned to the group of persons; and assign, by the at least one processor to each respective person within the group of persons based on the first user input and the second user input, a respective seat with the determined building section and a respective schedule during which the respective seat is to be occupied by the respective person.

The processor may be further configured to apply a first algorithm that uses a machine learning technique to perform the assigning. The first algorithm may be trained by using historical data that relates to a prior seat occupancy pattern of each respective person with the group of persons.

The processor may be further configured to: transmit, via the communication interface to each respective person within the group of persons, seat assignment information that is generated as a result of the assigning; and receive, via the communication interface from at least one person within the group of persons, a response to the transmitting of the seat assignment information that indicates at least one from among a confirmation of the seat assignment information, a declination of the seat assignment information, and a proposed amendment to the seat assignment information.

The processor may be further configured to receive, via the communication interface, a third user input that includes at least one personal preference that relates to at least one person within the group of persons. The assigning of the respective seat and the respective schedule to the at least one person may be further based on the third user input.

The processor may be further configured to cause the display to display, on a graphical user interface, an image that illustrates a result of the determining and the assigning.

The processor may be further configured to determine at least one metric that relates to at least one from among building space availability and seat occupancy. The at least one metric may include at least one from among an average building occupancy, a seat occupancy percentage at a particular time, an average seat occupancy percentage over a particular week, and an average seat occupancy percentage over a particular month or other predetermined amount of time.

The processor may be further configured to generate a report that includes information that relates to maximizing seat occupancy and information that relates to a degree of adherence between the first user input, the second user input, and a result of the determining and the assigning.

The processor may be further configured to: receive, via the communication interface, actual occupancy information that indicates, for each respective seat on a particular day, whether the respective seat is actually occupied and an identification of a person occupying the respective seat; and compare the actual occupancy information with a result of the determining and the assigning.

The processor may be further configured to cause the display to display, on a graphical user interface, a result of the comparing.

According to yet another aspect of the present disclosure, a non-transitory computer readable storage medium storing instructions for automatically assigning seats to a group of persons is provided. The storage medium includes executable code which, when executed by a processor, causes the processor to: receive a first user input that relates to building space availability and a second user input that relates to employer requirements for seat occupancy; determine, based on the first user input and the second user input, a building section within which seats are to be assigned to the group of persons; and assign, to each respective person within the group of persons based on the first user input and the second user input, a respective seat within the determined building section and a respective schedule during which the respective seat is to be occupied by the respective person.

When executed by the processor, the executable code may further cause the processor to apply a first algorithm that uses a machine learning technique to perform the assigning. The first algorithm may be trained by using historical data that relates to a prior seat occupancy pattern of each respective person with the group of persons.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for automatically assigning seats to personnel based on behavioral patterns and hybrid work schedules that include working from home and working at an office at different times.

FIG. 4 is a flowchart of an exemplary process for implementing a method for automatically assigning seats to personnel based on behavioral patterns and hybrid work schedules that include working from home and working at an office at different times.

FIG. 5 is a first screen shot of a downloadable application that implements a process for automatically assigning seats to personnel based on behavioral patterns and hybrid work schedules that include working from home and working at an office at different times, according to an exemplary embodiment.

FIG. 6 is a second screen shot of a downloadable application that implements a process for automatically assigning seats to personnel based on behavioral patterns and hybrid work schedules that include working from home and working at an office at different times, according to an exemplary embodiment.

FIG. 7 is a third screen shot of a downloadable application that implements a process for automatically assigning seats to personnel based on behavioral patterns and hybrid work schedules that include working from home and working at an office at different times, according to an exemplary embodiment.

FIG. 8 is a fourth screen shot of a downloadable application that implements a process for automatically assigning seats to personnel based on behavioral patterns and hybrid work schedules that include working from home and working at an office at different times, according to an exemplary embodiment.

FIG. 9 is a fifth screen shot of a downloadable application that implements a process for automatically assigning seats to personnel based on behavioral patterns and hybrid work schedules that include working from home and working at an office at different times, according to an exemplary embodiment.

FIG. 10 is a sixth screen shot of a downloadable application that implements a process for automatically assigning seats to personnel based on behavioral patterns and hybrid work schedules that include working from home and working at an office at different times, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

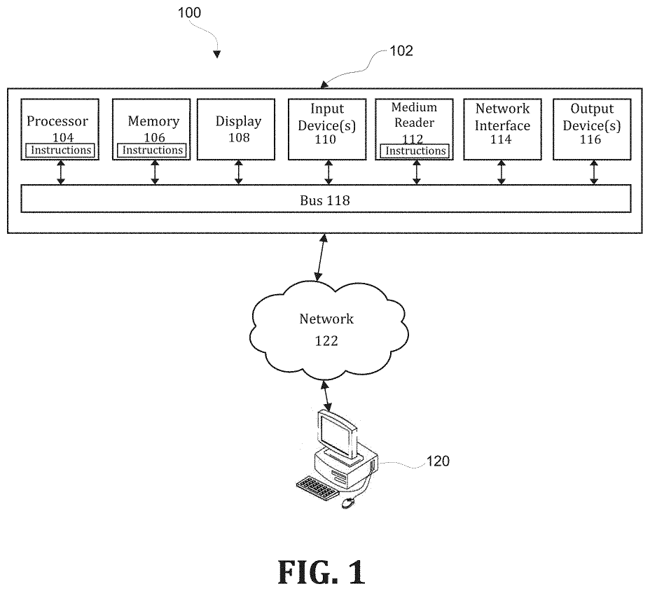

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for automatically assigning seats to personnel based on behavioral patterns and hybrid work schedules that include working from home and working at an office at different times.

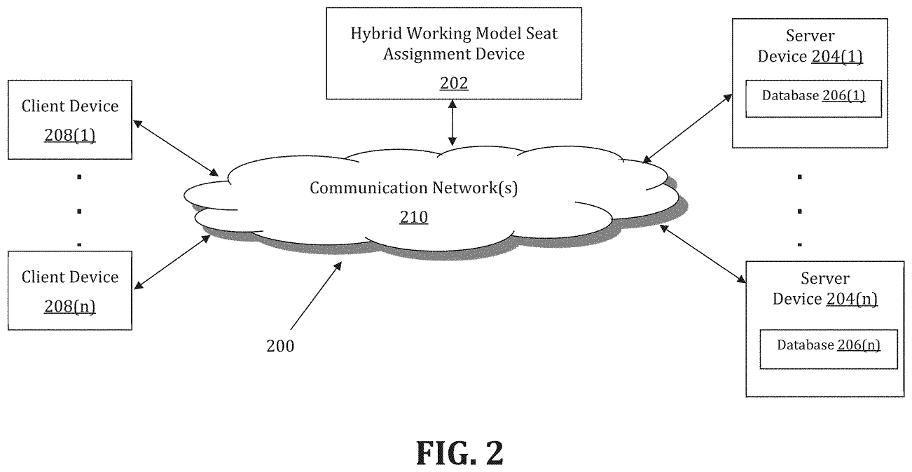

Referring to FIG. 2, a schematic of an exemplary network environment 200 for implementing a method for automatically assigning seats to personnel based on behavioral patterns and hybrid work schedules that include working from home and working at an office at different times is illustrated. In an exemplary embodiment, the method is executable on any networked computer platform, such as, for example, a personal computer (PC).

The method for automatically assigning seats to personnel based on behavioral patterns and hybrid work schedules that include working from home and working at an office at different times may be implemented by a Hybrid Working Model Seat Assignment (HWMSA) device 202. The HWMSA device 202 may be the same or similar to the computer system 102 as described with respect to FIG. 1. The HWMSA device 202 may store one or more applications that can include executable instructions that, when executed by the HWMSA device 202, cause the HWMSA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the HWMSA device 202 itself, may be located in virtual server(s) running in a cloud-based computing environment rather than being tied to one or more specific physical network computing devices. Also, the application(s) may be running in one or more virtual machines (VMs) executing on the HWMSA device 202. Additionally, in one or more embodiments of this technology, virtual machine(s) running on the HWMSA device 202 may be managed or supervised by a hypervisor.

In the network environment 200 of FIG. 2, the HWMSA device 202 is coupled to a plurality of server devices 204(1)-204(n) that hosts a plurality of databases 206(1)-206(n), and also to a plurality of client devices 208(1)-208(n) via communication network(s) 210. A communication interface of the HWMSA device 202, such as the network interface 114 of the computer system 102 of FIG. 1, operatively couples and communicates between the HWMSA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the HWMSA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and HWMSA devices that efficiently implement a method for automatically assigning seats to personnel based on behavioral patterns and hybrid work schedules that include working from home and working at an office at different times.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The HWMSA device 202 may be a standalone device or integrated with one or more other devices or apparatuses, such as one or more of the server devices 204(1)-204(n), for example. In one particular example, the HWMSA device 202 may include or be hosted by one of the server devices 204(1)-204(n), and other arrangements are also possible. Moreover, one or more of the devices of the HWMSA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the HWMSA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to employer-specific schedule requirements and constraints and data that relates to employee-specific behavioral patterns and preferences.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the HWMSA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the HWMSA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the HWMSA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the HWMSA device 202, the server devices 204(1)-204(n), or the client devices 208(1)-208(n), for example, may be configured to operate as virtual instances on the same physical machine. In other words, one or more of the HWMSA device 202, the server devices 204(1)-204(n), or the client devices 208(1)-208(n) may operate on the same physical device rather than as separate devices communicating through communication network(s) 210. Additionally, there may be more or fewer HWMSA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof

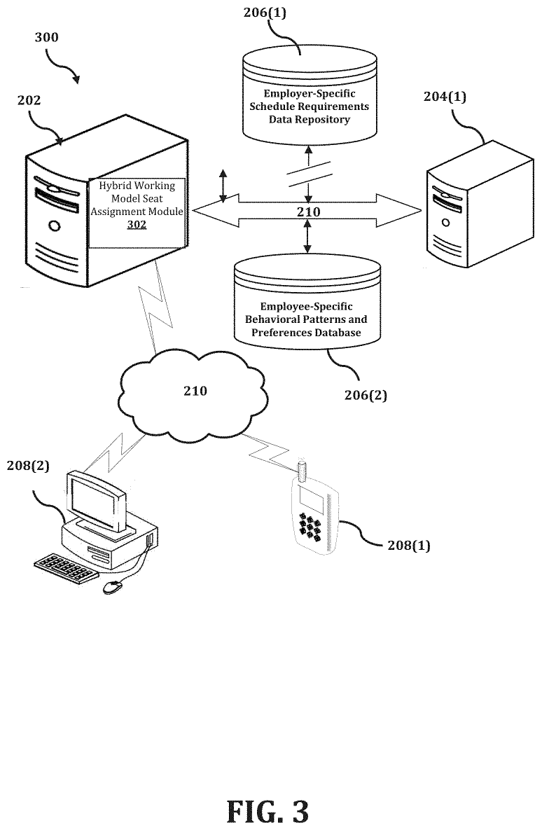

The HWMSA device 202 is described and illustrated in FIG. 3 as including a hybrid working model seat assignment module 302, although it may include other rules, policies, modules, databases, or applications, for example. As will be described below, the hybrid working model seat assignment module 302 is configured to implement a method for automatically assigning seats to personnel based on behavioral patterns and hybrid work schedules that include working from home and working at an office at different times.

An exemplary process 300 for implementing a mechanism for automatically assigning seats to personnel based on behavioral patterns and hybrid work schedules that include working from home and working at an office at different times by utilizing the network environment of FIG. 2 is illustrated as being executed in FIG. 3. Specifically, a first client device 208(1) and a second client device 208(2) are illustrated as being in communication with HWMSA device 202. In this regard, the first client device 208(1) and the second client device 208(2) may be “clients” of the HWMSA device 202 and are described herein as such. Nevertheless, it is to be known and understood that the first client device 208(1) and/or the second client device 208(2) need not necessarily be “clients” of the HWMSA device 202, or any entity described in association therewith herein. Any additional or alternative relationship may exist between either or both of the first client device 208(1) and the second client device 208(2) and the HWMSA device 202, or no relationship may exist.

Further, HWMSA device 202 is illustrated as being able to access an employer-specific schedule requirements data repository 206(1) and an employee-specific behavioral patterns and preferences database 206(2). The hybrid working model seat assignment module 302 may be configured to access these databases for implementing a method for automatically assigning seats to personnel based on behavioral patterns and hybrid work schedules that include working from home and working at an office at different times.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the HWMSA device 202 via broadband or cellular communication. Of course, these embodiments are merely exemplary and are not limiting or exhaustive.

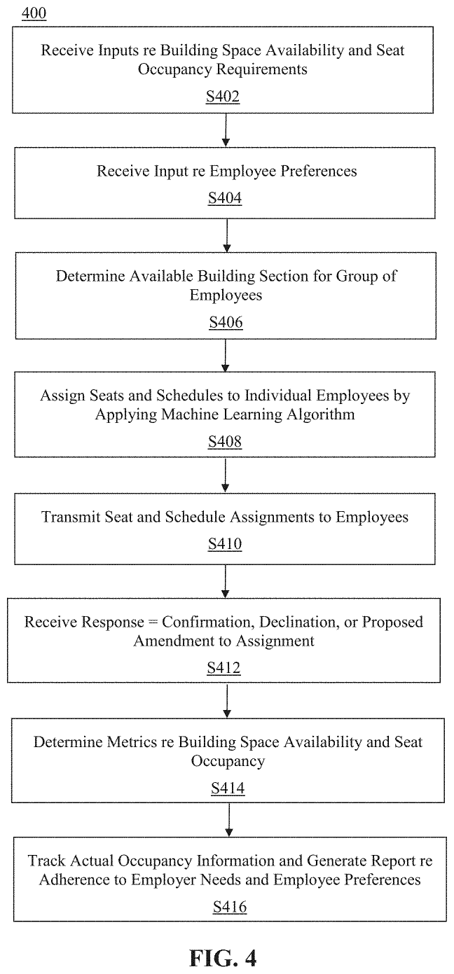

Upon being started, the hybrid working model seat assignment module 302 executes a process for automatically assigning seats to personnel based on behavioral patterns and hybrid work schedules that include working from home and working at an office at different times. An exemplary process for automatically assigning seats to personnel based on behavioral patterns and hybrid work schedules that include working from home and working at an office at different times is generally indicated at flowchart 400 in FIG. 4.

In process 400 of FIG. 4, at step S402, the hybrid working model seat assignment module 302 receives a first user input that relates to building space availability and a second user input that relates to employer requirements for seat occupancy. In an exemplary embodiment, the input that relates to building space availability may include information that indicates a number of floors in the building and a number of seats on each floor. In an exemplary embodiment, the input that relates to employer requirements for seat occupancy may include a number of employees included in a particular group or team and a number of persons that are expected to be physically present on a particular day of the week and during a specific time interval within the particular day of the week. Then, at step S404, the hybrid working model seat assignment module 302 receives a third user input that relates to personal preferences of at least one employee. The personal preferences may include, for example, preferences with respect to scheduling times for being physically present at the office versus working from home and/or preferences with respect to specific accommodations, such as, for example, a preference to use a standing desk, a specific type of chair, and/or any other such personal preference.

At step S406 the hybrid working model seat assignment module 302 determines an available building section for a particular group or team of employees based on the inputs received in step S402. Then, at step S408, the hybrid working model seat assignment module 302 assigns seats and schedules to individual employees within the particular group or team based on the inputs received in steps S402 and S404. In an exemplary embodiment, the determination of the available building section and the seat and schedule assignments may be implemented by applying an algorithm that uses a machine learning technique and is trained by using historical data that relates to a prior seat occupancy pattern of each respective employee within the particular group or team. In an exemplary embodiment, the seat and schedule assignments may be illustrated by generating an image that is displayable via a graphical user interface (GUI), in order to facilitate an efficient explanation as to which seats are to be occupied by which persons at a particular time.

At step S410, the hybrid working model seat assignment module 302 transmits the seat and schedule assignments to each employee within the particular group or team. Then, at step S412, the hybrid working model seat assignment module 302 receives a response from each employee, or a predetermined time elapses without a response. In an exemplary embodiment, the received responses will indicate one of the following: 1) a confirmation that the seat and schedule assignment is acceptable to the employee; 2) a declination, i.e., a notification that the employee does not intend to comply with the seat and schedule assignment; or 3) a proposed amendment by which the employee indicates a proposed change to either or both of the assigned seat and the assigned schedule. In an exemplary embodiment, when an employee that has received a seat assignment fails to respond by a particular time, such as, for example, 10:00 am on a given day, then the seat may be released into the available pool of seats. Further, when an employee responds by declining the proposed assignment, the seat may be released into the available pool of seats. The process 400 may then return to step S406 to account for the released seats.

At step S414, the hybrid working model seat assignment module 302 determines a set of metrics that relate to building space availability and seat occupancy. In an exemplary embodiment, the metrics may include one or more of an average building occupancy, a seat occupancy percentage, an average seat occupancy over a particular week, an average seat occupancy over a particular month, and/or an average projected building occupancy or an average projected seat occupancy over any specified time interval. In an exemplary embodiment, the metrics may be illustrated by generating graphs and charts that are displayable via a GUI, in order to facilitate an efficient explanation as to how well the building resources are being used.

At step S416, the hybrid working model seat assignment module 302 tracks actual occupancy information and generates a report that indicates a degree of adherence to employer requirements as provided in the input received in step S402 and also a degree of adherence to employee preferences as provided in the input received in step S404. In an exemplary embodiment, the report may include information that indicates, for each respective seat on a particular day, whether the respective seat is actually occupied and an identification of the person that occupies the respective seat, and an indication as to whether the actual occupancy of the respective seat matches with the seat and schedule assignment that had previously been made in step S408. Information included in the report may be illustrated so as to be displayable via a GUI.

In an exemplary embodiment, when the report indicates a lack of compliance with occupancy constraints, such as, for example, firm guidelines, local jurisdictional regulations, and/or governmental physical distancing guidelines, there may be a need to rebalance seat assignments based on the occupancy constraints. In this scenario, the hybrid working model seat assignment module 302 may return to step S406.

In an exemplary embodiment, a process for automatically assigning seats to personnel based on behavioral patterns and hybrid work schedules that include working from home and working at an office at different times may be implemented as an application (“app”) that is downloadable to a smart phone and/or other type of computing device. The app may include various graphical user interfaces that facilitate entry of user inputs, such as, for example, information regarding requested times and dates for obtaining a seat assignment in a particular building and information regarding personal preferences. In an exemplary embodiment, the app may also include a health check button by which an individual person may enter data that indicates a health condition that may impact the seat assignment process. In an exemplary embodiment, the app may also be able to retrieve information about a geographical location of the smart phone or other device to which the app has been downloaded, and to use the location information as part of the seat assignment process.

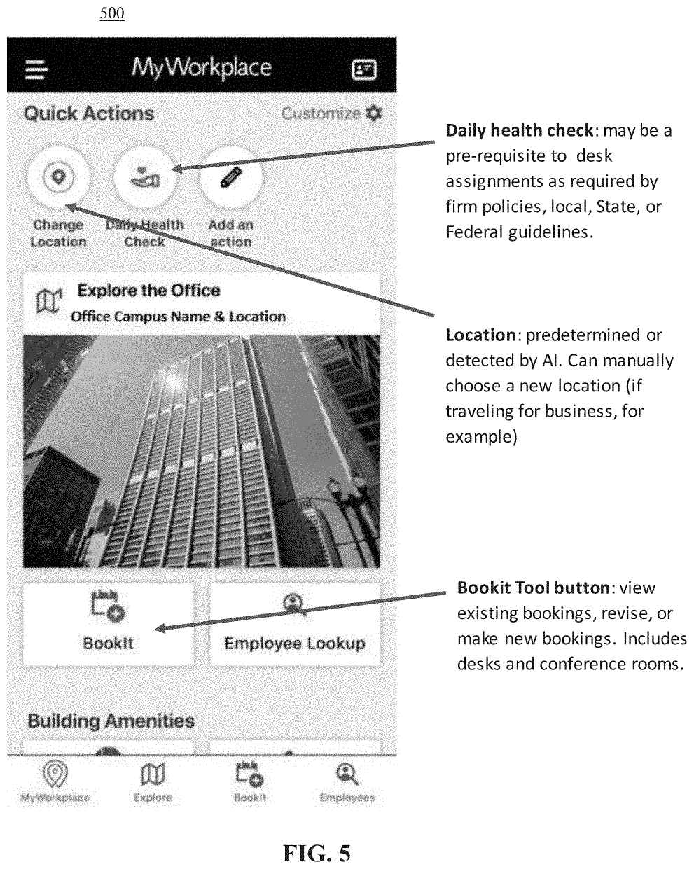

FIG. 5 is a first screen shot 500 of a downloadable app that implements a process for implementing a method for automatically assigning seats to personnel based on behavioral patterns and hybrid work schedules that include working from home and working at an office at different times, according to an exemplary embodiment. As illustrated in screen shot 500, the app may include user-friendly buttons that facilitate user inputs for various functions, including changing a location, performing a daily health check, adding an action, and executing the app (labeled here as a “BookIt Tool button) in order to view existing seat assignments (i.e., bookings), revising existing bookings, and making new bookings. The bookings may be made with respect to desks and/or conference rooms. As also illustrated in screen shot 500, the app is usable for facilitating retrieval of information about an office, i.e., an office campus name and location, and retrieval of information that relates to individual employees in a particular office, i.e., an employee lookup.

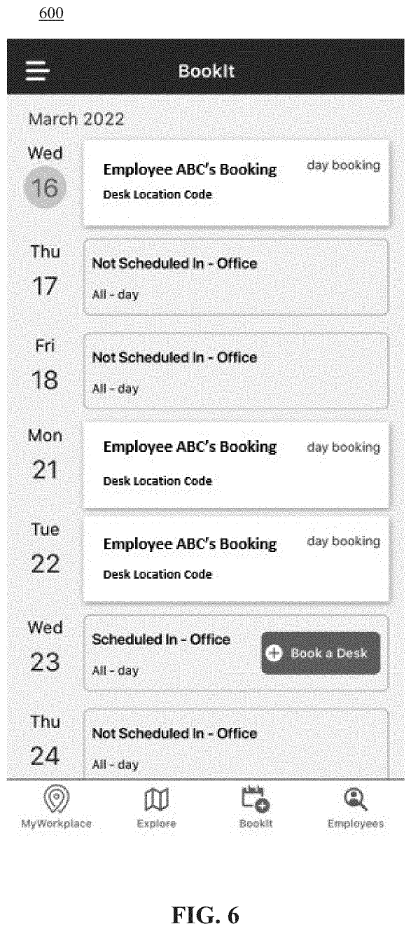

FIG. 6 is a second screen shot 600 of a downloadable application that implements a process for automatically assigning seats to personnel based on behavioral patterns and hybrid work schedules that include working from home and working at an office at different times, according to an exemplary embodiment. As illustrated in screen shot 600, the app may display a listing of upcoming dates accompanied by information indicating a seat assignment for a particular employee for each date. In particular, the information may include an indication as to whether the employee is scheduled to be in the office, a desk location code, an indication as to a time schedule (i.e., “day booking”), and/or any other suitable type of information that relates to a schedule of seat assignments.

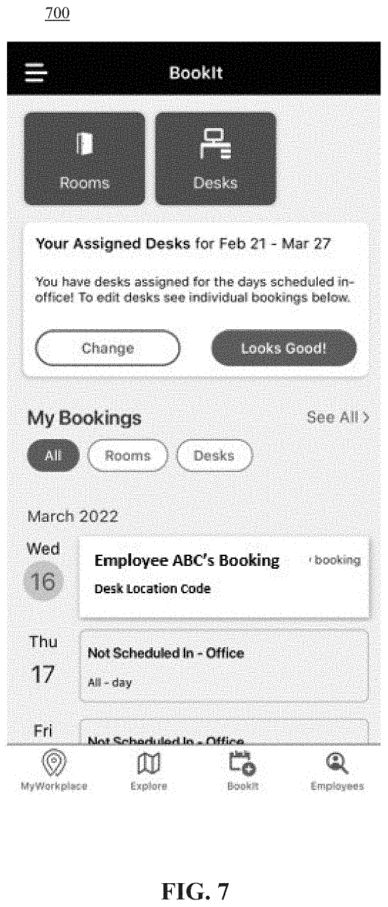

FIG. 7 is a third screen shot 700 of a downloadable application that implements a process for automatically assigning seats to personnel based on behavioral patterns and hybrid work schedules that include working from home and working at an office at different times, according to an exemplary embodiment. As illustrated in screen shot 700, the app may provide buttons by which a user may execute the app with respect to rooms and/or desks, and a button that enables the user to change an assignment or confirm that the bookings are acceptable.

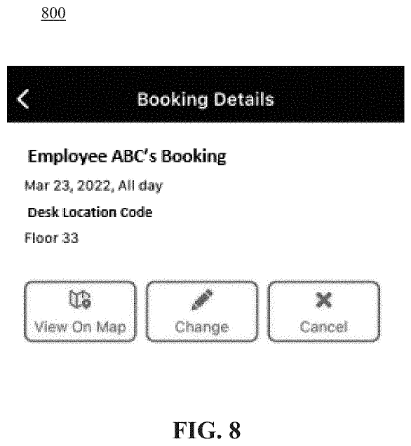

FIG. 8 is a fourth screen shot 800 of a downloadable application that implements a process for automatically assigning seats to personnel based on behavioral patterns and hybrid work schedules that include working from home and working at an office at different times, according to an exemplary embodiment. As illustrated in screen shot 800, the app may display an assignment for a single date, including an identification of the date and time for which the seat assignment is effective, and also a desk location code and a floor number. The app may also provide buttons by which a user may view the seat assignment on a map of the floor, change the seat assignment, or cancel the seat assignment.

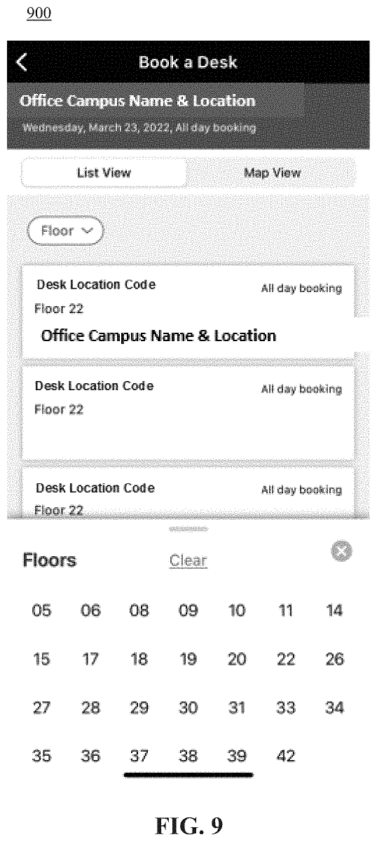

FIG. 9 is a fifth screen shot 900 of a downloadable application that implements a process for automatically assigning seats to personnel based on behavioral patterns and hybrid work schedules that include working from home and working at an office at different times, according to an exemplary embodiment. As illustrated in screen shot 900, the app may display a listing of desk location codes on a floor-by-floor basis, together with an indication as to whether or not each corresponding desk has been assigned for a particular date. The app may also provide a listing of floors to enable a user to select a floor for viewing such a listing.

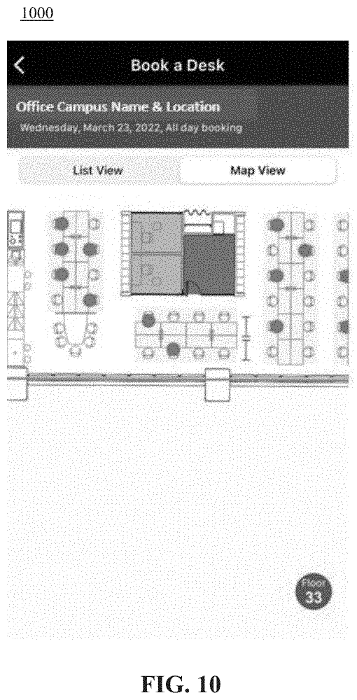

FIG. 10 is a sixth screen shot 1000 of a downloadable application that implements a process for automatically assigning seats to personnel based on behavioral patterns and hybrid work schedules that include working from home and working at an office at different times, according to an exemplary embodiment. As illustrated in screen shot 1000, the app may display a floor map that illustrates a layout of desks, together with indicators showing whether or not each desk has been assigned for a particular date. In this aspect, each desk is accompanied by a depiction of a chair, and when the chair is shown as blank or white, this indicates that the corresponding desk has not been assigned and remains available, whereas when the chair is shown as filled-in or darkened, this indicates that the corresponding desk has been assigned for the displayed date.

Accordingly, with this technology, an optimized process for automatically assigning seats to personnel based on behavioral patterns and hybrid work schedules that include working from home and working at an office at different times is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for automatically assigning seats to a group of persons, the method being implemented by at least one processor, the method comprising:
receiving, by the at least one processor, a first user input that relates to building space availability and a second user input that relates to employer requirements for seat occupancy;
determining, by the at least one processor based on the first user input and the second user input, a building section within which seats are to be assigned to the group of persons; and
assigning, by the at least one processor to each respective person within the group of persons based on the first user input and the second user input, a respective seat within the determined building section and a respective schedule during which the respective seat is to be occupied by the respective person.

2. The method of claim 1, wherein the assigning comprises applying a first algorithm that uses a machine learning technique to perform the assigning,
wherein the first algorithm is trained by using historical data that relates to a prior seat occupancy pattern of each respective person with the group of persons.

3. The method of claim 1, further comprising:
transmitting, by the at least one processor to each respective person within the group of persons, seat assignment information that is generated as a result of the assigning; and
receiving, by the at least one processor from at least one person within the group of persons, a response to the transmitting of the seat assignment information that indicates at least one from among a confirmation of the seat assignment information, a declination of the seat assignment information, and a proposed amendment to the seat assignment information.

4. The method of claim 1, further comprising receiving, by the at least one processor, a third user input that includes at least one personal preference that relates to at least one person within the group of persons,
wherein the assigning of the respective seat and the respective schedule to the at least one person is further based on the third user input.

5. The method of claim 1, further comprising displaying, on a graphical user interface, an image that illustrates a result of the determining and the assigning.

6. The method of claim 1, further comprising determining, by the at least one processor, at least one metric that relates to at least one from among building space availability and seat occupancy,
wherein the at least one metric includes at least one from among an average building occupancy, a seat occupancy percentage at a particular time, an average seat occupancy percentage over a particular week, and an average seat occupancy percentage over a particular month.

7. The method of claim 1, further comprising generating a report that includes information that relates to maximizing seat occupancy and information that relates to a degree of adherence between the first user input, the second user input, and a result of the determining and the assigning.

8. The method of claim 1, further comprising:
receiving, by the at least one processor, actual occupancy information that indicates, for each respective seat on a particular day, whether the respective seat is actually occupied and an identification of a person occupying the respective seat; and
comparing the actual occupancy information with a result of the determining and the assigning.

9. The method of claim 8, further comprising displaying, on a graphical user interface, a result of the comparing.

10. A computing apparatus for automatically assigning seats to a group of persons, the computing apparatus comprising:
a processor;
a memory;
a display; and
a communication interface coupled to each of the processor, the memory, and the display,
wherein the processor is configured to:
receive, via the communication interface, a first user input that relates to building space availability and a second user input that relates to employer requirements for seat occupancy;
determine, based on the first user input and the second user input, a building section within which seats are to be assigned to the group of persons; and
assign, by the at least one processor to each respective person within the group of persons based on the first user input and the second user input, a respective seat with the determined building section and a respective schedule during which the respective seat is to be occupied by the respective person.

11. The computing apparatus of claim 10, wherein the processor is further configured to apply a first algorithm that uses a machine learning technique to perform the assigning,
wherein the first algorithm is trained by using historical data that relates to a prior seat occupancy pattern of each respective person with the group of persons.

12. The computing apparatus of claim 10, wherein the processor is further configured to:
transmit, via the communication interface to each respective person within the group of persons, seat assignment information that is generated as a result of the assigning; and
receive, via the communication interface from at least one person within the group of persons, a response to the transmitting of the seat assignment information that indicates at least one from among a confirmation of the seat assignment information, a declination of the seat assignment information, and a proposed amendment to the seat assignment information.

13. The computing apparatus of claim 10, wherein the processor is further configured to receive, via the communication interface, a third user input that includes at least one personal preference that relates to at least one person within the group of persons,
wherein the assigning of the respective seat and the respective schedule to the at least one person is further based on the third user input.

14. The computing apparatus of claim 10, wherein the processor is further configured to cause the display to display, on a graphical user interface, an image that illustrates a result of the determining and the assigning.

15. The computing apparatus of claim 10, wherein the processor is further configured to determine at least one metric that relates to at least one from among building space availability and seat occupancy,
wherein the at least one metric includes at least one from among an average building occupancy, a seat occupancy percentage at a particular time, an average seat occupancy percentage over a particular week, and an average seat occupancy percentage over a particular month.

16. The computing apparatus of claim 10, wherein the processor is further configured to generate a report that includes information that relates to maximizing seat occupancy and information that relates to a degree of adherence between the first user input, the second user input, and a result of the determining and the assigning.

17. The computing apparatus of claim 10, wherein the processor is further configured to:
receive, via the communication interface, actual occupancy information that indicates, for each respective seat on a particular day, whether the respective seat is actually occupied and an identification of a person occupying the respective seat; and
compare the actual occupancy information with a result of the determining and the assigning.

18. The computing apparatus of claim 17, wherein the processor is further configured to cause the display to display, on a graphical user interface, a result of the comparing.

19. A non-transitory computer readable storage medium storing instructions for automatically assigning seats to a group of persons, the storage medium comprising executable code which, when executed by a processor, causes the processor to:
receive a first user input that relates to building space availability and a second user input that relates to employer requirements for seat occupancy;
determine, based on the first user input and the second user input, a building section within which seats are to be assigned to the group of persons; and
assign, to each respective person within the group of persons based on the first user input and the second user input, a respective seat within the determined building section and a respective schedule during which the respective seat is to be occupied by the respective person.

20. The storage medium of claim 19, wherein when executed by the processor, the executable code further causes the processor to apply a first algorithm that uses a machine learning technique to perform the assigning,
wherein the first algorithm is trained by using historical data that relates to a prior seat occupancy pattern of each respective person with the group of persons.
